(19) United States
(12) Patent Application Publication
(10) Pub. No.: US 2008/0035569 A1
(43) Pub. Date: Feb. 14, 2008

(54) Water Treatment Device and Method Therefor

(76) Inventors: Haim Wilder, Raanana (IL); Abraham Domb, Efat (IL)

Correspondence Address: RATNERPRESTIA, P.O. BOX 1596, WILMINGTON, DE, 19899, US

(21) Appl. No.: 10/598,545

(22) PCT Filed: Oct. 15, 2004
(86) PCT No.: PCT/IB04/03375

§ 371 Date: Jun. 29, 2007

Related U.S. Application Data
(60) Provisional application No. 60/549,144, filed on Mar. 3, 2004.
(60) Provisional application No. 60/583,592, filed on Jun. 30, 2004.

(51) Int. Cl. C02F 1/28; C02F 1/42; C02F 9/00

(52) U.S. Cl. 210/650; 210/473

(57) ABSTRACT

A system for upgrading raw water using a filter, for eliminating intrinsic factors of such water. Optionally the system includes a device for facilitating sustained release of extrinsic factors supplied by one or more capsules. Optionally the system includes also a dosing device for prolonging the constant supply of extrinsic factors to the drinking water to a period of time beyond that which is facilitated by one capsule laden with the factors. The filter of the system forces the gravitationally trickling raw water to meander through a path in which it reacts with a set of reactants. Upgraded after having passed through the filter, the water is collected and made available for dispensing through a spout. Optionally, one or more capsules laden with health promoting, nutritive, remedies or other beneficial factors are added to the upgraded water. A number of techniques for facilitating a substantially constant addition of vitamins, minerals, and other beneficial chemicals is described.

### TECHNICAL FIELD OF THE INVENTION

The present invention relates generally to the field of water treatment systems. More specifically, the present invention is in the field of systems used for converting raw or partially treated water, into human-consumable water. and enrichment of drinking water with additives using dosing devices.

### BACKGROUND OF THE INVENTION

Raw water is oftentimes found to be in a quality level unacceptable as judged by health standards, on account of its undesirable contents such as toxic matter, pathogens and radioactive nuclides. In addition, such raw water may contain matter which can render it unsatisfactory with regard to palatability or appeal to the eye. Treatment measures to ameliorate water are usually applied by state, municipal authority, or by the individual consumer. These treatment measures typically include chemical, physical, and biological procedures that aim at eliminating undesirable suspended and dissolved matter. In U.S. Pat. No. 5,543,056 is disclosed a method for removing colour and particles, from drinking water by the use of chitosan in combination with a clay mineral. Chitosan is a derivative of chitin which is a natural polymer consisting of chains of acetylated glucosamine, usually extracted from shells of marine crustaceans. Chitosan is a fully or partially deacetylated chitin, wherein the naturally occurring amido bonds are hydrolyzed, leaving the amino groups of the polymer exposed and active.

Despite municipal or state treatment measures, resultant water is often not considered a reliable source for drinking water. Thus, concerned consumers opt for purchased canned or bottled water in order to ensure reasonable quality drinking water. However, bottled water are relatively expensive and may contain industrial contaminants derived from the walls of the container, in addition to the original natural impurities.

Several types of domestic water treatment systems are known in the art. Some rely on directly applied external energy for treating the water, for example distillation devices and ultraviolet irradiators. Other systems employ physical and or chemical processes that do not consume direct external energy. Among these some employ ion exchangers for eliminating ions such as calcium and other metal ions, and others employ activated carbon for mainly eliminating organic matter, dissolved gases and toxic materials; nevertheless some systems employ both ion exchangers and activated carbon. U.S. Pat. No. 4,717,476 discloses an apparatus for purifying water that employs a sequence of purification steps, each step accomplishes a different aspect of purification in a separate unit such that in the final step a desired product is obtained. U.S. Pat. No. 4,749,481 discloses a device and method for upgrading water quality for household use by using small, disposable disc-like elements that contain active material. These discs can be used in stacks thus performing successive steps of water treatment, each by a different disc element in the stack.

Home appliances for ameliorating consumer water are available in the market, that require connection to the home inlet, thus benefiting from the pressurized water supply provided by the local authorities. The pressure is used to drive the water through one or more cartridges that contain ion exchangers, and or activated carbon. Manufacturers of such devices recommend replacement of cartridges on a regular basis as well as other components of these systems that deteriorate in time. Other home appliances which do not require connection to the home plumbing, are pour-through water pitchers, typically containing cation exchange resins and activated carbon granules in their filters. Such filters often contain silver for preventing the build up of bacterial colonies, and generally require regular replacement. Some home water purifying systems contain easily replaceable parts so as to allow easy maintenance by the owner. In U.S. Pat. No. 5,989,424 the replaceable component is a filter cartridge.

Upgrading the water for human or animal consumption may be achieved not only by filtering out intrinsic factors of the water, but also by adding extrinsic factors. As can be seen in FIG. 1A to which reference is now made, raw water is collected, for example by drawing from a well, in step 20. Then, in step 22 undesirable factors are eliminated wholly or partially from the collected water. In step 24 the resultant water is dispensed. In FIG. 1B another approach to upgrading of water is described schematically. In step 30, raw water is collected, to be supplied with extrinsic factors in step 32. The enriched water is dispensed in step 34. Elimination of intrinsic factors may be brought about by the physical retention of particulate, biotic or abiotic material on a sieve, letting the water pass through, or the elimination of undesired chemical factors, for example metal ions, by retention on an ion exchange resin, while water passes through. The enrichment of water may serve the cause of health promoting such as by supplementing a specific mineral in an environment deficient in such a mineral. An invention for carrying out such enrichment is described in WO03059092.

### BRIEF DESCRIPTION OF THE DRAWINGS

FIG. 1A is a schematic description of a water treatment of the prior art applying intrinsic factor elimination;

FIG. 1B is a schematic description of a water treatment of the prior art applying extrinsic factor addition;

FIG. 2 is a schematic description of a water treatment applying both elimination and elimination;

FIG. 3 is a schematic isometric view of the bottom sell of the filter of the invention;

FIG. 4A is a cross sectional view of filter of the invention;

FIG. 4B is a cross sectional view of a filter of the invention including a receptacle for an additive laden capsule;

FIG. 5 is an isometric view of a filter of the invention including a receptacle for an additive laden capsule;

FIG. 6 is an isometric cross sectional view of a filter of the invention including a receptacle for an additive laden capsule;

FIG. 7A is a schematic isometric view of a magazine dispenser showing capsule chambers;

FIG. 7B is a schematic isometric view of a magazine dispenser showing screen blocking chambers;

FIG. 8 is a schematic description of a magazine dispenser using a closed channel for dropping capsules into the auxiliary receptacle.

FIG. 9A is an isometric view of the stopped end of a spout of the water upgrading system of the invention;

FIG. 9B is a is an isometric view of the lid of the spout with the lower lip in an upright position;

FIG. 9C is an isometric view of the lid of the spout with the lower lip is deflected downwards facilitating entrance of air to the lower compartment position.

FIG. 9D is a cross sectional view of spout and lid showing the ventilation mechanism facilitation air intake into the lower water compartment.

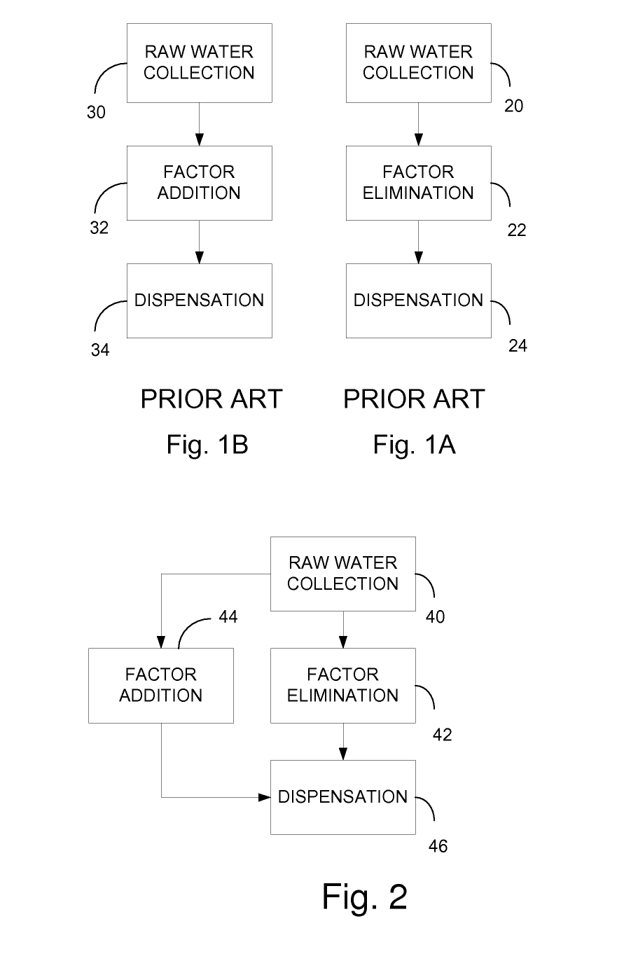

### DETAILED DESCRIPTION OF THE PRESENT INVENTION

A system manufactured in accordance with the present invention supplies water for human consumption, such that available raw water is converted by the system into higher grade water by using devices and applying methods as will be elaborated in the following description. The system of the invention may be used as a provider of daily drinking water, performing until some of the functional reactants are depleted. A device of the invention implements gravitational percolation of raw water through a filter which upgrades the seeping water. Typically, the device of the invention is embodied in the form of a bottle. Such a bottle consists at least of four main parts: an upper water compartment, a lower water compartment, a filter and a pouring spout. Such a bottle is used for water purification as well as enrichment with nutritional additives. A filtration unit separates the upper and the lower water compartments. The spout drains the lower water compartment and conveys the water to a user thereof. The lower and upper water compartments are expandable allowing for compaction or distension. Each water compartment is autonomously expandable forming a firm expanded bottle which folds up to a minimal volume upon application of force. A lid shuts off the spout and another lid can close the water filling orifice. In order to fill the bottle with raw water, the upper water compartment is distended, water trickles by gravitation through the filter, passing through the delivery device, filling the lower water compartment with filtered and enriched water, which can be removed through the spout.

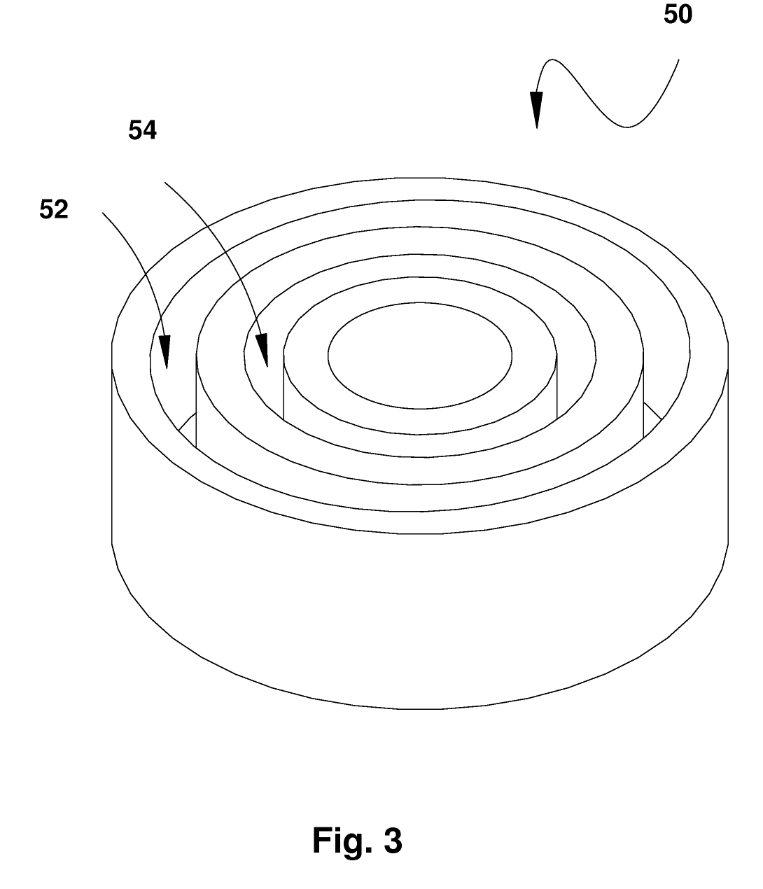

In a preferred embodiment of the invention raw water is upgraded in two ways, as described schematically in FIG. 2 to which reference is now made. Raw water is collected at step 40, to be further treated in two different ways. In step 42 undesired factors are partially or wholly eliminated. In step 44 beneficial factors are added and in step 46 the water is dispensed.

The Filter Reactants

A filter of the device of the invention contains a set of reactants. Water percolating down the filter passes through and reacts with components of the set of reactants. In a preferred embodiment of the instant invention, three reactants are used, each of a different category, as follows: A. a weak acid cation exchanger made of an anionic polymer, typically having carboxylic groups as the functional group, B. activated carbon, and C. a weak base anion exchanger, made of a cationic polymer. The three components act each by its own virtue to modify the seeping raw water such that the resulting water is of higher quality. Within the filtration chamber, the reactants may be disposed fully mixed to partially mixed, or layered in one or more separate layers. The polyanionic component is typically granulated, containing pores, and the activated carbon is likewise, typically granulated. The polycation is employed in the physical form of granules, and may also be used in the form of flakes. The reactants are typically bound together by a chemical binder. The binder holds the particles together, typically in a random mixture, preventing segregation associated with particle size or specific weight. The application of a binder must not altogether impede the movement of water passing through the filter. The binder is either water soluble or water insoluble. Soluble binder species are water soluble polymers such as poly(vinyl pyrrolidone), polyacrylates, gelatin and pregelatinized starch. Non water soluble binders are for example cross-linked poly(vinyl pyrrolidone), chitosan, cellulose derivatives and crosslinked or water insoluble acrylic acid copolymers. Water soluble polymers may be washed into the drinking water and should therefore be either drinkable or disposed of first. Poly(vinyl pyrrolidone) is a binder well suited for the task yet pharmaceutically acceptable and therefore is a preferable binder in this invention. To keep the pH of the treated water in a proper range, typically between 7.0 to 7.4, fit for drinking, at least a part of the acid residues of the acid iron exchange are pre-charged at least partially with alkali metal ions or basic earth-alkaline metal ions.

Filter Structure and Function, Additive Capsule Auxiliary Receptacle and Dispensing System

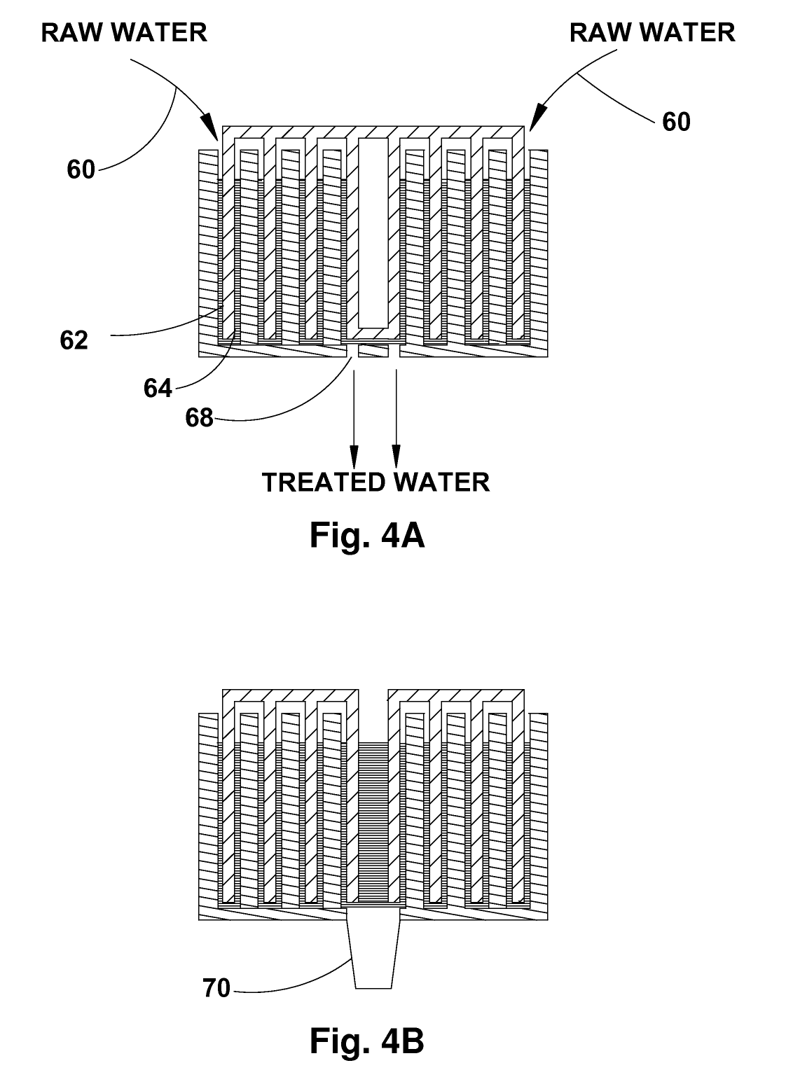

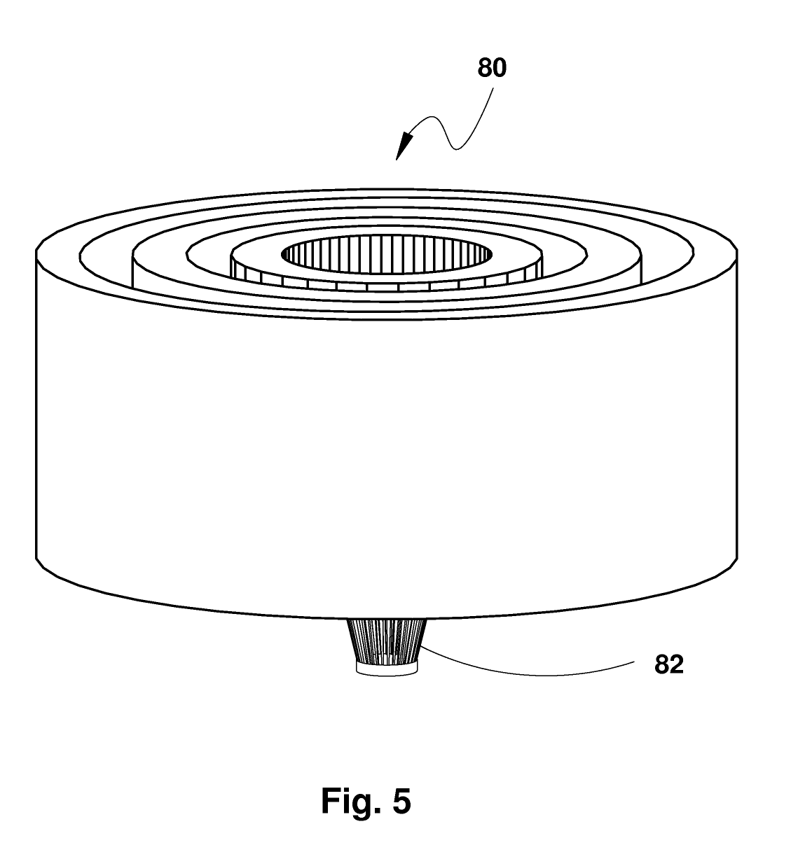

In order to increase the interaction of the water undergoing conversion, a filter element is provided that forces the water to follow a serpentine route in association with the reactants. The filter element in such an embodiment is composed of a lower and an upper shells in a structured intercalated as will be scribed infra. To explain this, reference is made to FIG. 3 which shows the bottom shell 50 of the filter element. Circular crevices 52 and 54 are shown. These crevices are filled with reactants as described in the cross section of FIG. 4A. A matching shell is then superimposed on the bottom shell. Raw water coming into the filer as indicated by arrows 60, flows down vertically along the crevice 62 and then up the next crevice, 64, coming out finally at opening 68. The water thereby follows a vertical meandering path, providing ample contact with the reactants.

In another embodiment of the invention as described schematically in FIG. 4B, a receptacle 70 is attached at the bottom of the filter for inserting a capsule (referring hereinafter also to a tablet) containing releasable extrinsic additive. In FIG. 4C a variant of the last embodiment is shown, in which a tubing 76 is fitted in the filter, for letting an additive laden capsule be put at will into the receptacle even as water treatment is on-going. Such a capsule may is optionally made as a compressed mineral block solubilised by the treated water. In such a case, a colored indicator is optionally inserted in the block such that when the block is depleted, the indicator shows through the walls of the device.

An example of an analysis trial in which raw water was analyzed before and after passing through the filter of the invention is given next. The filtration system was assembled and tap water was passed through the filter. Samples of filtered water were taken from the 1, 3, 50 and 100^{th} liter of water passing through the filter. Five filters were used in the study, 3 of them without binder, containing about 65 grams of the filtration mixture. The filtered water was analyzed by Aminolab laboratories, Rehovot, Israel, using well determined test methods (see number of test in parenthesis). The following parameters were determined: pH (test procedure SM 4500−H+B), color (test procedure SM2120B), clarity (test procedure SM2130B), anions (test procedure SM 4500), total solids (test procedure SM2540 B) and total organics (test procedure SM 3120B) and metal ion content (test procedure SM 3120B). Typical data is given in the following Tables 1 and 2. The results show that there is no difference between the water samples up to 100 liters. All samples complied with the standard requirements for drinking water including the pH, color and clarity. The color test is a standard test in which the color of water is compared to the standard cobalt-platinum (CoPt) developing color. The clarity is given in nephelometric turbidity units (NTU). The anions content as well as the total solids are within the allowable range for drinking water. A typical metal ion content is given in Table 2. Metal ions were at a very low level except for the essential metal ions, Ca and Mg which were in the appropriate levels, respectively.

TABLE 1
parameters measured in filtered water

| Water passing through the filter | | | units | Test parameter |
|---|---|---|---|---|
| 100^{th} liter | 50^{th} liter | 5^{th} liter | — | — |
| 7.2 | 7.3 | 7.2 | — | pH |
| <5 | <5 | <5 | CoPt standard | color |
| 0.1 | 0.2 | 0.2 | NTU | clarity |
| 97 | 97 | 98 | mg/liter | (Cl⁻) |
| 92 | 90 | 95 | mg/l | (SO₄⁻²) |
| 61 | 60 | 60 | mg/l | (NO₃⁻) |
| <0.1 | <0.1 | <0.1 | mg/l | (NO₂⁻) |
| 736 | 652 | 604 | mg/l | Total solids of matter |
| | | | | dried at (105° C.) |
| 1.1 | 1.2 | 4.6 | mg/l as C | Total organics (TOC) |
| 365 | 353 | 133 | mg/l as CaCO₃ | CaCO₃ |

TABLE 2
Metal ion content in mg/liter

| | | | Metal |
|---|---|---|---|
| Volumes of water passing through the filter | | | ion |
| 100^{th} liter | 50^{th} liter | 5^{th} liter | — |
| 0.01 | 0.01 | 0.01 | Ag |
| 0.06 | 0.05 | <0.05 | Al |
| <0.05 | <0.05 | <0.05 | As |
| 0.08 | 0.07 | 0.02 | Ba |
| 119 | 114 | 42 | Ca |
| <0.005 | <0.005 | <0.005 | Cd |
| 0.02 | 0.04 | 0.01 | Cr |
| 0.01 | 0.01 | <0.01 | Cu |
| 0.01 | 0.02 | 0.03 | Fe |
| 1.5 | 1.7 | 152 | K |
| 16 | 16 | 7 | Mg |
| <0.01 | <0.01 | <0.01 | Mn |
| 43 | 44 | 75 | Na |
| <0.01 | <0.01 | <0.01 | Ni |
| <0.01 | <0.01 | <0.01 | Pb |
| <0.01 | <0.01 | <0.01 | Se |
| 0.2 | 0.2 | 0.05 | Zn |

The filtered water was also inspected for the presence of bacteria. The water samples were analyzed for general count using the pour plate (SM 9215B), coliforms (test procedure SM 9215B), feces coliforms (test procedure SM 9222D), feces streptococcus (test procedure SM 9230C). The general bacterial count of the 100^{th} filtered litter is 111 compared to a 1000 count for the pre-filtered water. No specific bacterial count (<1) was found in all samples. This trial indicates the efficiency of the filters of the invention. No difference was found between the filters prepared with or without povidone. It should be noted that all five filters used in this study were of homogeneously distributed filter particles.

In a separate experiment, one liter samples of tap water had their pH adjusted to pH of 5.5, 6.0, 7.0 and 8.0 (using HCl and NaOH as needed) respectively. The water were filtered through the filter of the invention and the pH and clarity were measured. The obtained pH was between 7.0-7.2 with high clarity (<5) as measured by the CoPt method.

The effect of the homogeneity of the filter particulate was examined as follows: Uniform mixture of the particulate components was loaded in the filter plastic frames. The loaded filters where treated as follows: two filters were used for filtration of tap water, two filters were vibrated for 30 minutes which separates the black powder of carbon to the bottom of the filter, and to filters were drove in a car for one hour which also separated the carbon particle to the bottom. These filters were used for water filtration. A significant delay in the filtration time and variability was determined for the segregated filters which vary from 3 minutes to 12 minutes per littler. The homogeneous filters filtered water at a constant rate for the 100 litters passed through the filters. To keep the filters homogeneously dispersed without the vibration effect, the particulate mixture (65 g) was mixed with a 0.2% solution of Povidone 30K (10 ml) and the wet mixture was dried at room air over night to obtain a dry homogeneous granules. The granules were loaded in filter holders and the effect of vibration on the segregation of the particles was determined. No segregation was noticed. When water was applied for filtration, the passing rate of water was not affected and was in the range of 3 minutes per litter. The povidone binder was not detected in the filtered water as measured in the 5^{th} to the 100^{th} liter of filtered water.

The filter of the invention removes fouling agents such as color and odor bearing agents from the raw water, thus making them more palatable and potentially healthier. To demonstrate odor removal, a solution of 0.5 grams of hexanoic acid in one litter of water was prepared. This solution was passed through the filter of the invention and a complete removal of the odor was achieved. This indicates that the filter reactant composition is capable of removing typical odors such as effected by short organic acids. Taking out the chitosan from the filter, made the filter considerably less effective as judged by the smell of filtered water using such a deficient filtration combination. The filter of the invention was also tested for its efficacy in removing coloring agents. To that effect, a solution of Brilliant Blue (0.1 mg per ml) was passed through the filter and the solution was determined by the presence of any color. The results showed that.

Beneficial Extrinsic Factors to be Added for Upgrading the Raw Water and Dispensing Devices for the Deployment Thereof

The system of the invention lends itself easily to be utilized as a personal health promoting and water enriching unit. The drinking water basically produced by the device of the invention, can be used conveniently as a carrier for minerals, vitamins and other beneficial factors and remedies supplied for improving the health and well being of humans. To the several classes of remedies belong a number of sub-classes such as minerals, vitamins, medicines but also flavorings and additives to improve water taste. The system can be used for the supply of remedies such as weight agents, plant extracts and homeopathic agents for improved health and feeling of the customer. The systems can be used for the delivery of drugs and medical treatment agents for children that refuse to take their medications so that the medications are delivered in the drinking water in very low doses with or without the knowledge of the child. Similarly, the system can be used for the long term supply of medications to avoid low compliance of elderly patients.

Known in the art are dispensing systems that releases a single dose in a form of a tablet, capsule or a liquid aliquot to the water collecting chamber triggered automatically as a result of accumulation of water in the chamber, stream of water passing through a tube which activates the dispensing system, or other means known in the art. Such systems can be utilized in the system of the present invention.

The mineral compositions to be delivered to the drinking water from this system may include ions such as calcium, magnesium, selenium, iron, zinc, fluoride and manganese that are promoters of good health. The ions are derived from one or various salts, for example, calcium fumarate or calcium lactate can fully or partly replace calcium chloride if chloride is to be avoided for a low chlorine diet. An artificially mineralized balanced drinking water fortified with mineral and vitamin additives can be maintained using the device. Thus enriched water as produced in accordance with the invention may contain either or a combination of minerals, vitamins, natural remedies that have positive effect on humans, homeopathic agents and even ethical drugs. For example, mineralized drinking water comprises water, water-soluble compounds of calcium, magnesium and fluorine having a specified concentration and contains one non-organic or organic compound of calcium, magnesium and fluorine whose concentration in terms of calcium, magnesium and fluorine is equal to 0.05-200 mg/l; 0.1-140 mg/l and 0.05-1.5 mg/l respectively and bicarbonates at a concentration ranging from 30 to 400 mg/l. Other additives are water-soluble iodine compounds, inorganic selenium compound, potassium ions, and silver ions at a specified concentration. Other remedies optionally included are natural medicine composition based on plant extracts, natural Chinese and far-east medicine accorded with hygienic standards. Since the system of the present invention may be used to provide drinking water for daily consumption, the user can conveniently strive to achieve such goals as enhancing the resistance of the body to disease, delay aging and confer other positive effects on the human by drinking such functional water. The weight reducing water is high-quality mineral water or other drinking water reaching the relevant sanitary standard with added natural weight reducing herbal medicine extracts. Drinking it can reach the aims of quenching thirst and reducing weight. Furthermore, the system of the present invention can be used to provide drinking water conforming with sanitary standards presumably capable of reducing blood fat by adding extracts of natural medicinal herbs including ginseng, salvia root, gynostemma pentaphyllum etc.

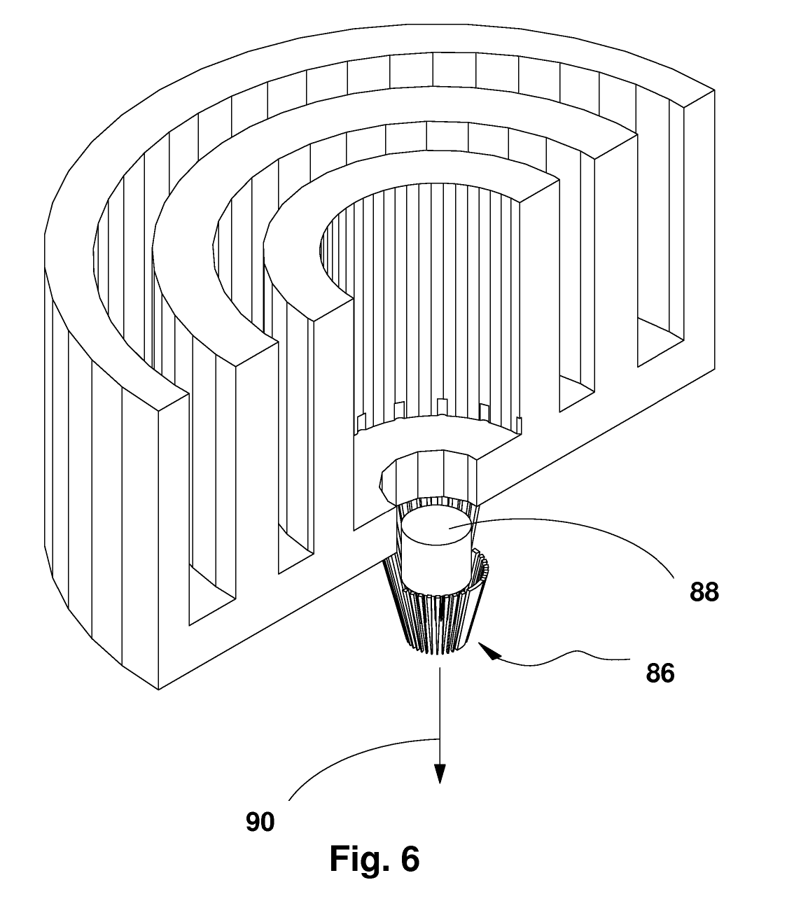

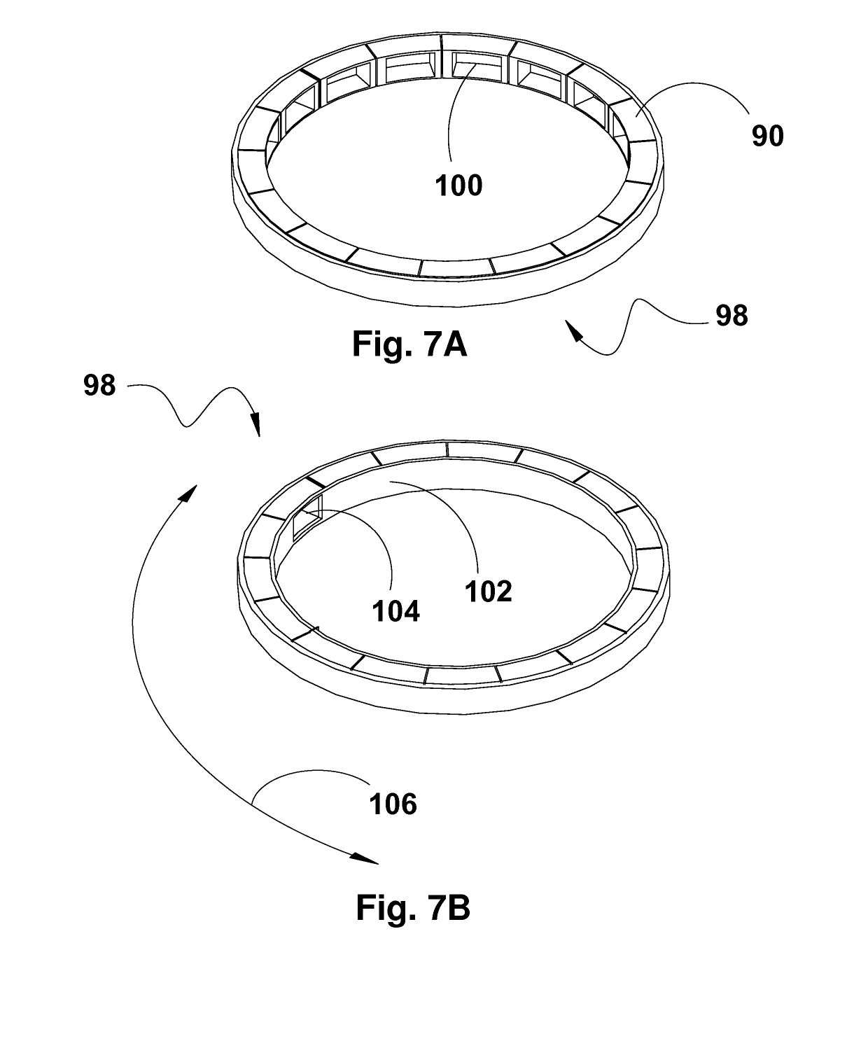

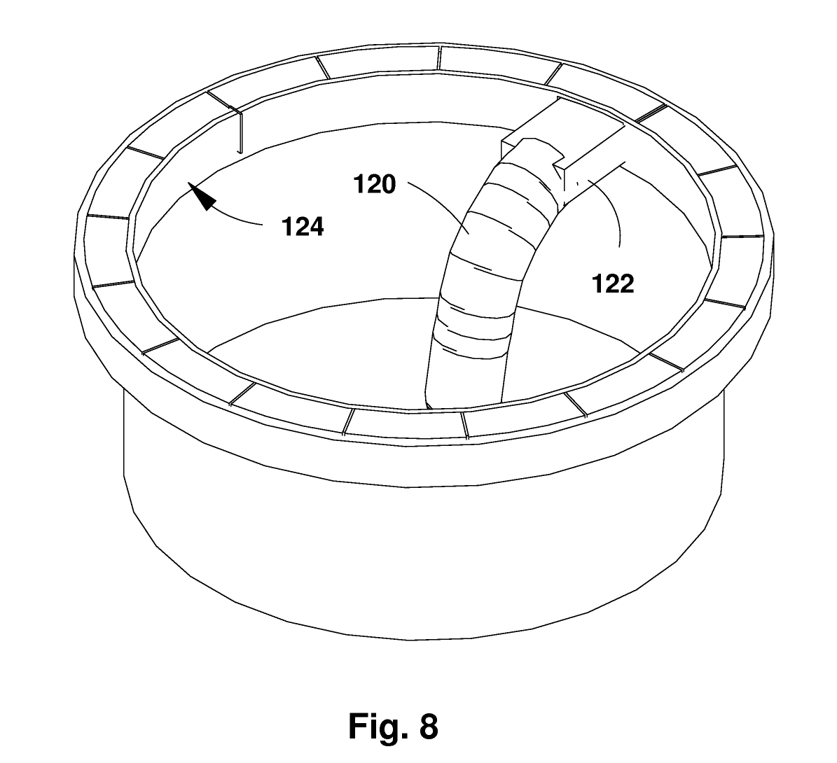

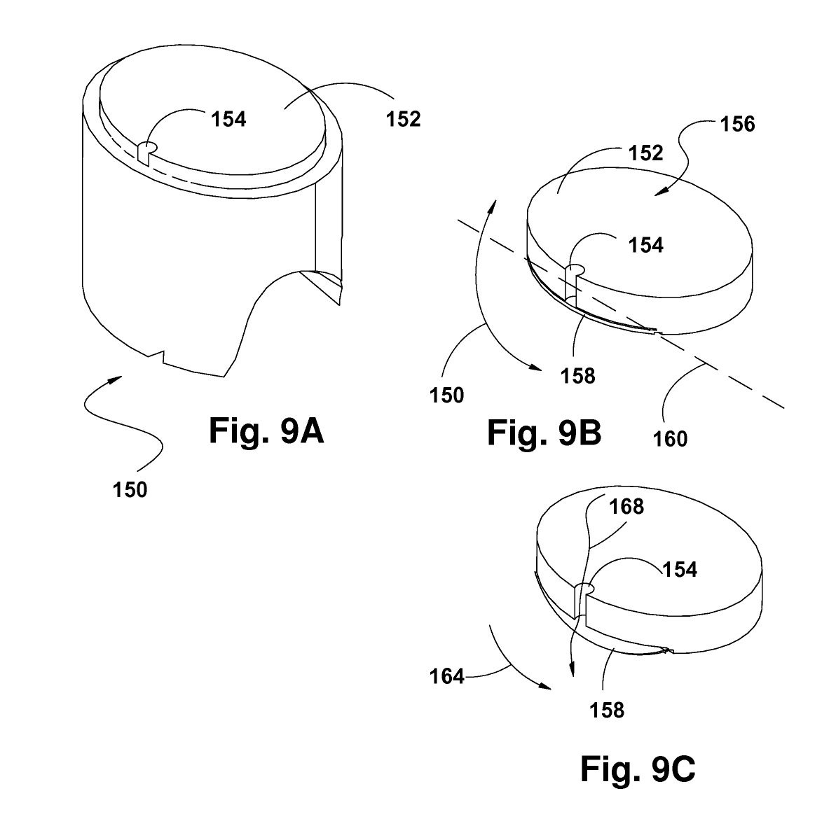

Means for introducing such additives are described next. Capsules or tablets laden with one or more beneficial factors are introduced into a receptacle at the bottom of the filter as described above. This is shown schematically also in FIGS. 5-6 to which reference is now made. In FIG. 5, filter 80 has a porous receptacle 82 installed in its bottom. In FIG. 6 a cross sectional view in a filter of the invention having a receptacle 86 installed, shown interior exposed, bearing a capsule 88. Arrow 90 indicates the direction of the drained treated water. The capsule 88 in fact represents many types of capsules, tablets, fast dissolving films, lozenges, slurries or solutions laden with one or more extrinsic factors the nature of which will be described infra. The one capsule shown is in an embodiment of the invention a component of the device which interacts with the upgraded water and liberates into the treated water factors beneficial for the drinker. This liberation is typically slow so as to match the expected depletion that the filter as a whole or one of its components. Moreover, the ideal concentration in the treated water of a factor liberated from the capsule is constant. Another approach for keeping the concentration of additives in the treated water substantially constant is by employing a magazine dispenser containing a number of capsules each containing the selected additive or a combination thereof. The magazine in case of a round device is round. To explain how such a magazine is employed, reference is made to FIGS. 7A-B. Annular magazine 98 contains chambers such as chamber 100 open to the center of the circle. In FIG. 7B a screen 102 is shown disposed, blocking all of the chambers except for one chamber, designated 104. By turning the screen 102 relative to the magazine in the direction double arrow 106, it is possible to expose all the chambers, one at a time. Since the capsules are to be deployed when the water treatment process is active, it is undesirable to have them fall into the raw water situated above the filter. Therefore, a closed channel is employed in one embodiment, as can be seen in FIG. 8 to which reference is now made. Channel 120, with its collector 122, are able to transfer the capsule discharged from the magazine to the receptacle beneath the filter. In such a case the magazine 124 and the channel is static with respect to the water treatment device (not shown in full).

The size and shape of the capsule or tablet containing the additives to be delivered is by the dispensing device is determined by the volume of the powders (in the case of tablets to be compressed (dose per unit) and the dispensing device requirements. The preferred tablet is stable throughout shipment and storage with minimal disintegration or breakage. It is also stable in the dispensing device during its use, after the start of filtration. Such a tablet dissolves quickly and completely in water to provide clear water without any turbidity or particles. Preferably the distribution of contents in the water requires minimal shaking. The amount of inert additives that do not contribute to the quality of water is kept to a minimum.

Tablets containing minerals are prepared by compression molding of a proper mixture of mineral salts with minimal additives used for binding the minerals. The salts that are used for the preparation of these tablets are non-hygroscopic so that the tablets do not absorb moisture prior to use. In a typical experiment, tablets were made by direct compression Mg-lactate and Ca-lactate at a Mg:Ca ion mole ratio of 1:2. The obtained tablet is not fragile and can be used without the addition of a binder. However, common binders such as poly(vinyl pyrrolidone) (Povidone K30) or pre-gelatinized starch are used in the amount of 0.5-1.5% where the binder is pre-mixed with the salt mixture either as fine powder or by wet granulation with an ethanolic or aqueous solution of the binder. A capsule may be covered by walls forming an envelope and may be segregated into compartments.

Controlled Discharge of Extrinsic Factors

Osmotically driven systems for delivering drugs either by swallowing a tablet such as the OROS® system (by Alza Corporation, 1900 Charleston Road, Mountain View, Calif., USA) or implanted in animals such as the osmotic minipump demonstrated by Alza Corporation USA, are known in the art. In one embodiment of the present invention, a releasing system having one compartment laden with additives is driven by osmotic pressure causing a stream release through orifice in the envelope of the single compartment. In such a system minerals or a mixture of minerals and vitamins or remedies as compressed solid tablet, slurry in water or a solution are loaded in the internal compartment which is a reservoir having a semi-permeable membrane that allows water to penetrate the chamber. Such a penetration into the chamber is accompanied by an increase in the pressure inside the chamber which in turn injects a stream of solutions of the actives out of the chamber through orifices.

An example of a device employed in the water treatment system device of the present invention for providing additives to the water produced is given below. In this example the delivery system is composed of an enveloped plastic chamber having an orifice or orifices located in its walls. The chamber is loaded with the mineral composition in a form of a compressed tablet, a slurry or a solution and a semi-permeable membrane. The orifices are sealed with either a removable patch or with a water soluble or degradable glue such as gelatin or poly(ethylene glycol) (PEG). Upon immersion of the chamber in aqueous media such as tap water, the seals are dissolved and the orifices opens allowing water diffusion in and out of the device. Subsequently water penetrates into the chamber through the semi-permeable membrane to dilute and dissolve the mineral salts and gradually build osmotic pressure inside the chamber which drives out concentrated solution of the mineral salts through the orifices. The diffusion of solution through the orifices continues as long as the semi-permeable membrane portion of the chamber envelope is immersed in water where water diffuses into the chamber driven by osmotic pressure. When water is no longer in contact with the membrane there is no build-up of osmotic pressure and the diffusion of concentrated solution minerals stops. When the device is exposed again to water, penetration of water into the chamber through the semi-permeable membrane proceeds and release of mineral solution from the chamber to the water is activated.

Dialysis is a simple technique to exchange a solute's solution or to separate/purify differently sized molecules. Macromolecules are dialyzed by placing them in size-selective permeable tubing and subsequently equilibrating the sample with large volumes of new buffer: efficient dialysis relies upon appropriate selection of dialysis tubing and effective ‘washing’ that results from large volumes, multiple changes and full equilibration with the new buffer. Dialysis tubing is made of either regenerated cellulose (RC) or cellulose ester (CE). Cellulose has long been used for dialysis as it is uncharged and does not readily absorb solutes. Further, the selectivity of cellulose membranes is not altered greatly by many chemicals or reasonable pH and temperature ranges. Processed cellulose has crystalline regions and these regions cross-link chains to introduce structural integrity to the cellulose. Depending upon how the cellulose is processed the number of crystalline areas varies and the resultant regions between the cross-links can act like size-selective pores. Many Dialysis tubing membranes are available with molecular weight cut offs (MWCO) from as little as 0.1 kDa all the way up to 300 kDa. MWCO values represent the size at which a solute is 90% retained during a test period. The small pore sizes available mean that relatively small molecules can easily be processed. In this study we tried to use this technique in order to receive zero order vitamin release profile.

In one experiment, mineral salts (14 g) composed of calcium chloride and magnesium chloride at a ratio of about 2:1 w/w were compressed into an ABS (acrylonitril-butadiane-styrene copolymer) plastic chamber of 4 cm high and 2.2 cm in diameter and sealed with a cellulose dialysis tubing membrane with a cut-off of about 12,000. The chamber has several orifices of different sizes form 50 microns to 1000 microns in diameter located in the envelope of the chamber. The orifices can be of various shapes with the simplest one being a circular hole of the same diameter across the chamber all. These orifices are made by either laser beam destructive current, mechanical drilling, or simply by punctuation with a hot needle of different gage size. In this particular experiment, orifices were made with a hot 22 G needle that melts the plastic forming uniform holes across the chamber's envelope. One, two four and eight and sixteen orifices were made along the chamber envelope at specific sites such as 10 mm from bottom and 10 mm from the top of the chamber. The orifices were sealed with a melted solution of gelatin or with melted PEG 4000.

Chambers of the same composition and shape but with a different number of orifices were prepared and immersed in one liter of water at room temperature with orbital shaking at 50 rpm. Every 15 minutes a sample of 10 ml solution was taken for analysis and every one hour, the water was replaced with fresh water. The experiment was continued for 3 hours in triplicates. The concentration of minerals in the releasing medium taken during the experiment was determined by atomic absorption. The average amounts released to the water, calculated as percent of the amount of minerals included in the chamber was as follows: After an induction time of about 15 minutes where less than 2% of the mineral content was released, a constant release of minerals was obtained with about 30% of the minerals constantly released per hour from the 8 orifice system. Faster release profile was obtained for the 16 orifice system and slower release from the 4 orifice system. To shorten the induction time, which is attributed to the initial solubilization of the compressed tablet, a 20% by weight of water was mixed with the mineral salts to form a paste loaded in the chamber. The rate of release is controlled by the number and size of the orifices, the properties of the semi-permeable membrane. In a different experiment, a mixture of CaCl₂ (30 g) and MgCl₂ (21.2 g) was dried overnight in a 50° C. oven and pulverized to a uniform salt mixture. Twelve grams of the salts were compressed in plastic caps (2 cm in diameter and 4 cm height) and 8, 16 or 24 holes were made on the cap's walls. The holes were made half on them at about the third height from bottom and half in the upper third part of the wall. The caps were sealed on the upper side with a dialysis membrane 12000-14000 Da cut-off. The salts loaded capsules were fully placed in 800 ml of deionized water (DDW) and samples were taken every 20 minutes. After each hour the DDW water was replaced with fresh water. Ca²⁺ and Mg²⁺ concentrations were determined by Atomic Absorption. After an induction time of 20 minutes where about 3% of the calcium and magnesium were released, the release was constant for the next 90 min, with about 90%, 65%, and 40% of the minerals were released from the 24, 16 and 8 holes capsules.

In a different approach, the minerals are disposed as an aqueous within the capsule, to be subsequently liberated into the drinking water without being solubilised first. Such a use is described in the following example. Three small plastic cups containing eight circular holes of about 500 micron in diameter (prepared either by laser current or by heat piercing using needles of different gage) were loaded with 16 ml of 60% w/v CaCl₂ aqueous solution. The caps were sealed with a cellulose dialysis tubing of a molecular weight cut-off of 12,000-14,000 Da on the upper face. Each cup was placed into 800 ml of deionized water on shaker stand and sample were withdrawal every 10 minutes. The release medium was replaced by fresh water after 30 min. After one hour the experiment was terminated and a sample of the solution in the caps was taken to determine the amount of calcium remained in the plastic cup. The concentrations of calcium in the samples taken during the experiment were determined by a spectrophotometric method. The method involves dilution of the solutions to calcium concentrations in the range of 0.1 to 0.5 mg/ml and than addition of a diluted solution of o-creosolphthalein complexone (CPC) (available from Aldrich) to obtain a purple color. The concentration of calcium was determined by spectrophotometer at 575 nm. Concentrations were calculated from a calibration curve prepared from the following calcium concentrations: 0.136 mg/ml, 0.182 mg/ml, 0.227 mg/ml, 0.341 mg/ml and 0.454 mg/ml. These concentrations provide a linear relation with optical densities of 0.1 to 0.42 with a slope of 0.56. A constant linear release of calcium was obtained between time zero to 50 minutes where all calcium content was depleted from the caps replaced by low concentration of calcium. After 1 h the calcium amount remained in the plastic cup is negligible, only 0.5-2.4% of the original amount. The release rate from the capsules is easily controlled by the size and number of holes. Using the same hole size of about 500 microns but varying the number of holes to have 2, 4, and 6 holes resulted in a proportional release amounts where the 2 holes released about 4 times longer than the 8 holes caps. Similarly, slurries of calcium and magnesium salts at concentrations of 65, 70, 75, and 80% w/v in water were prepared and used for the release of these minerals from the capsules. A constant release was obtained with almost no induction time. It should be noted that when mixtures of Mg and Ca salts were used, the slurries remain flowable even after being left for a long period of time in the capsules. However, if CaCl₂ was used without the addition of other components, it solidified forming a sparingly soluble block.

In an another example, the capsule described above was loaded with a slurry of calcium chloride (6 g), magnesium chloride (4 g) and trace amounts of selenium, zinc and iron salts in 4 ml of water. The capsule was sealed in one side with cellulose dialysis tubing with a 3,000 Mw cut-off. The capsule plastic cap had four holes on the wall on the same level, a pair of holes in each side. The holes were blocked with gelatin gel until put to trial. The capsule was placed in the receptacle located in the lower side of the filter with the membrane side down letting the water cover the membrane and the hole. The receptacle was compartmented such that its lower part had a solid, non-permeable envelope except for a few little holes at the bottom that allowed slow drainage of water after having been filled up with trickled water. This arrangement allowed good contact of water with the membrane and associated holes during water passage. Concentrated solution of the salts was released to the water as long as water passed through the filter and the device. When water trickling stopped and no water came out of the capsule holding chamber, no mineral solution was released through the holes. The amount of minerals released to the water during filtering of about 50 litters was constant. The average amount that was released was 10 mg/liter and 6 mg/liter for Ca and Mg salts, respectively.

To eliminate the possibility of dripping of liquids from the orifices prior to use, the orifices are sealed either with a water soluble or dispersible agent such as gelatin, alginate, poly(vinylpyrrolidone) and the like, which upon first contact with water, dissolve and expose the orifice. The time of opening of the orifices can be controlled by selecting different sealing compositions, the fast dissolving materials exposing the orifice shortly after immersing the capsule to water, whereas a slow dissolving seal exposes the orifice later. This system can be further modified by adding an inner enveloped chamber using an envelope made of a semi-permeable membrane forming an inner chamber containing salts such as CaCl₂. The surface of this internal envelope or portion thereof is exposed to the outer aqueous medium from which water osmotically diffuses into this envelope subsequently pushing out the mineral salts in the main chamber through the orifices in the walls of the main plastic chamber. The flexibility of the main chamber is not essential and chambers made of different polymers and materials are suitable as long as they are stable to the mineral solutions. Osmotically driven device without a semi-permeable membrane can also be used to obtain a constant release of solutions. A non-permeable chamber loaded with the solid minerals having orifices of different sizes in various locations of the chamber. When this chamber is immersed in water, water may penetrate into the chamber through the orifices, dissolve the salts and diffuse the salt solution through the orifices. This system is simpler than the previously described systems but the release of salts is less reproducible.

Vitamins and other active additives to be delivered to the treated water chamber can be mixed with the salts and released along with the salts through the orifices. This is relevant to vitamins and other active agents that are stable in high concentration solutions of salts. Alternatively, the sensitive actives may be packed is a closed flexible envelope having one or more orifices in such a way that a the osmotic pressure built-up in an adjacent envelop loaded with salts pushes out the solution of the additives.

Release of Additives from Diffusion Controlled Systems

Such systems are typically compressed tablet with additives suitable for dosing about 100 liters of water is encapsulated in a rate-controlling permeable membrane and the release is by diffusion through the membrane. This system is more suitable for non-electrolyte additives such as vitamins. The membranes that have been used in both systems are cellulose based dialysis tubing with a molecular weight cut-off of 0.3 and 1.2 KDa. In one experiment, the release rate of vitamins C and B1 was to evaluated, from a vitamin mixture loaded in dialysis tubing with molecular weight cut offs of 12-14 kDa. Four dialysis tubing with molecular weight cut offs of 12-14 kDa (estimated surface area, 4 cm², were loaded with a mixture contain 12 mg of vitamin B1 and 488 mg of vitamin C and sealed using elastic band. Each dialysis tubing was placed into 1 liter of deionized water (DDW) and mixed using a magnetic stirrer and sample were withdrawal every 20 minutes. The release medium was replaced by fresh DDW every 30 min. The experiment was terminated after 3 hours and the amount of vitamins remained in the dialysis tubing was determined.

The concentrations of the vitamins in the obtained liquids were measured by spectrophotometer at 285 nm and calculated from calibration curve prepared from the following solutions: 100 mg mixture/L, 50 mg mixture/L, 25 mg mixture/L, 12.5 mg mixture/L, 6.25 mg mixture/L, 3.13 mg mixture/L, and 1.56 mg mixture/liter. A linear correlation was obtained with OD in the range of 0.1 for the low concentration and 0.77 for the highest concentration, respectively with a slop of 13.5 and r>0.98. The vitamins were linearly released for 3 h with about 50% of the vitamin content was depleted from the tubing.

Release of Additives from a Matrix Type System

In such systems the additives are intercalated in a polymer matrix and released from the matrix by diffusion through channels within the matrix. Other delivery systems are mentioned in information submitted. In a typical experiment, a mixture of vitamin C, vitamin B₁ B₆ B₂ and B₁₂, niacin, folic acid, and iron salt at an amount of 10 times the recommended daily dose is mixed with a mixture of ethyl cellulose and hydroxypropyl cellulose at a weight ratio of vitamins:polymer powder 30:70. The mixture is compressed into a tablet. Other additives that can be included in the matrix powder are magnesium stearate as lubricant, lactose as water soluble release enhancing agent, microcrystalline cellulose and other additives commonly used in tablets. The tablets were coated by pan coating with Eudragite® (by Röhm GmbH & Co. KG) dispersion containing colors and additives that may protect the vitamins from humidity and light. Other matrix materials that can be used for the tablet are based on poly(methacrylic acid-methyl methacrylate). The release of vitamins from this matrix is constant over time following a first order release where higher aloes to linear amounts are released during the first 30 litters of water passing through the tablet followed by a gradual decrease in the vitamin concentration released to the passing water for the next 50 litters. The vitamin release from the matrix tablet can be better controlled by coating the tablet with a rate controlling membrane such as ethyl cellulose mixture with 5-10% poly(ethylene glycol) [PEG] as channeling agent. Other suitable polymers are cellulose acetate phthalate, cellulose acetate, and other synthetic and semi-synthetic rate controlling membranes.

Tablets of vitamins without matrix forming system that contain more than 85% vitamins with some stabilizers, weighing 2.0 g of vitamins were coated with cellulose acetate phthalate containing 10% w/w PEG 800 as channeling agent. Uniform coatings were obtained by serial dipping in dilute polymer coating solution or by spray dry using a rotating pan. Vitamins were released constantly for three hours when placed in filtered water. The vitamin release was monitored by HPLC.

Structural Aspect of the Container of the Invention

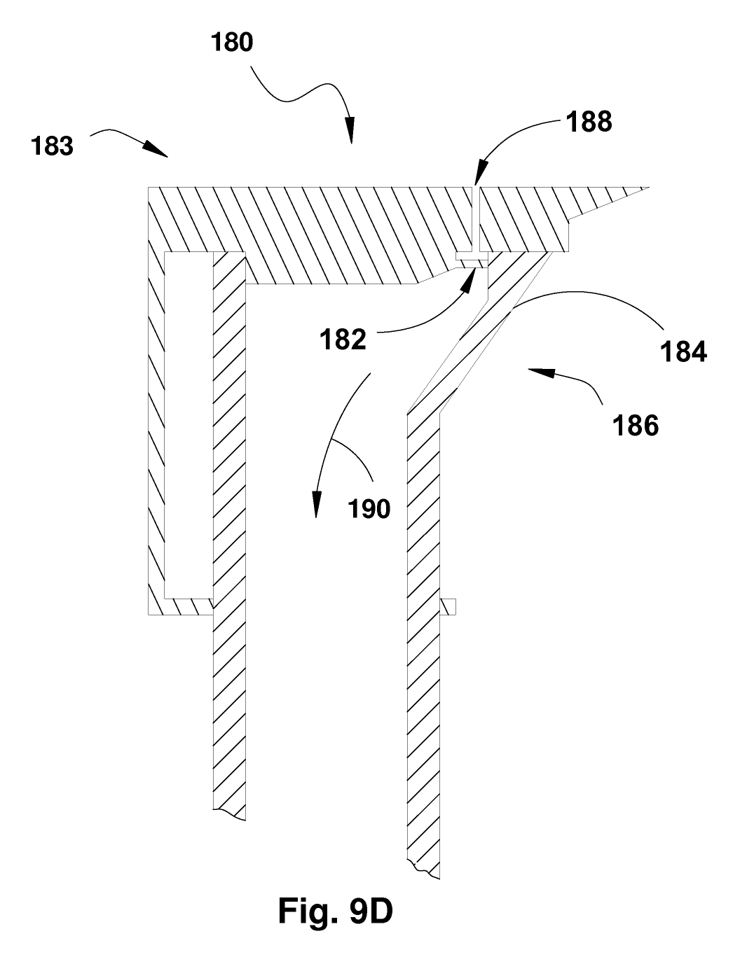

As described above the lower and upper compartments of a water treatment device of the invention are expandable. Expanding the top compartment gives room for raw water, waiting for interaction with the filter. The expansion of the bottom compartment allows for treated water to be stored until drained through the spout. When water is depleted from either top or bottom compartments or both, the entire device can resume compact dimensions at least partially, for ease of carriage or storage. In order to allow expanding the bottom compartment, a spout lid is provided that expansion folds allows air to enter the spout—bottom compartment continuum by forming a slit, when expanding stops. One such example is described with reference to FIGS. 9A-D

In FIG. 9A water spout 150 ends with stopper having a cover 152 and a breather 154. In FIG. 9B stopper 156 is shown with cover 152 and lower lip 158. Lower lip 158 is rotatable around virtual axis 160 in the direction indicated by double arrow 162. In FIG. 9C the lower lip is shown deflected downwards in the direction of arrow 164. Arrow 168 shows the direction of air coming through the breather 154 when the lower compartment is expanded. When the lower compartment is static, the lower lip 158 is drawn upwards as in FIG. 9B hermetically stopping the spout and preventing spillage of treated water. To fulfill this task efficiently the cover and the lower lip are typically made of a suitable elastomer. In FIG. 9D to which reference is now made, a cross sectional view of the lidded orifice 180 is shown. Lowe lip 182 of lid 183 is shown in a stopping position, abutting wall 184 of spout 186. Breather 188 allows air from the ambient to be sucked into the orifice in the direction of arrow 190 as lip 182 is deflected downwards (not shown).

The upper compartment lid is typically turned or otherwise manipulated to allow for air intake during expanding or during seepage of water down the filter. Air is extruded intentionally when the compartment is compacted.

1. A filter for upgrading raw water, wherein gravity forces water through said filter seeping from an upper compartment into a lower compartment and wherein said raw water follows a vertical meandering path interact with reactants filling said filter, said filter comprising:
concentric crevices filled with a set of reactants, and
a porous receptacle for a capsule disposed at the bottom of said filter, draining upgraded water from said filter.

2. A filter for upgrading raw water as in claim 1, and wherein said set of reactants comprise:
activated carbon;
a weak anion exchanger;
a weak cation exchanger, and
a binder for binding all said reactants.

3. A filter for upgrading raw water as in claim 2, and wherein said binder is an item selected from the group consisting of water soluble and water insoluble binders.

4. A device for upgrading raw water by filtering out intrinsic factors of said raw water and by adding at least one extrinsic factor, wherein said raw water stored in an upper water compartment are trained through a filter, to be collected as upgraded water in a lower water compartment, to be further drained by a spout.

5. A device as in claim 4 and wherein said at least one extrinsic factor is delivered by a capsule disposed in a receptacle attached to the bottom of said filter and wherein said capsule is enveloped.

6. A device as in claim 4 and wherein said at least one extrinsic factor is delivered by a capsule attached to the bottom of said filter wherein said capsule is a gel including channels for releasing intercalated extrinsic factors.

7. A device as described in claim 5 wherein at least a portion of the walls of said capsule is permeable to water, and wherein said walls have at least one orifice for connecting the enveloped chamber of said capsule with said upgraded water.

8. A device as described in claim 5 wherein the envelope of said capsule is generally non permeable to water except for at least one orifice through which external water can penetrate and at least one loaded factor can be released to the upgraded water.

9. A device as described in claims, 8 wherein said at least one orifice is sealed by a protective removable patch.

10. A device as described in claim 8 and wherein said at least one orifice is sealed by a water soluble glue and wherein said glue is eliminated upon exposure to water.

11. A device as described in claim 5 wherein the envelope of said capsule is generally non permeable except for at least one orifice, and wherein an inner capsule is disposed within said capsule a part of which inner capsule is permeable to water such that when immersed in water the inner capsule absorbs water and the inner capsule releases additives contained therein.

12. A device as described in claim 5 wherein said capsule is at least partially permeable to soluble solutes to allow diffusion into said upgraded water.

13. A device as in claim 4 wherein said at least one extrinsic factor is an item selected from the group consisting of minerals, vitamins and remedies and medicines.

14. A device as in claim 4 wherein said at least one extrinsic factor is a combination of at least two extrinsic factors selected from the group consisting of mineral salts, vitamins, remedies and flavouring agents.

15. A device as in claim 13 wherein said at least one extrinsic factor is an organic salt of metal ions selected from the group consisting of calcium, magnesium, selenium, zinc and other essential ions.

16. A device as described in claim 5 wherein the said extrinsic factor is disposed in said capsule in a form selected from the group containing compressed tablets, slurries and concentrated solutions.

17. A device as in claim 4 and wherein said at least one extrinsic factor is delivered by a capsule inserted in a receptacle attached to the bottom of said filter and wherein said capsule is discharged from a chambered magazine, passing through a channel on its way to said receptacle.

18. A filter for upgrading raw water as in claim 1, and wherein said weak anion exchanger is chitosan.

19. A method for removing fouling agents from raw water wherein said water follows a vertical meandering path in which said water interacts with a mixture of reactants filling said filter and wherein said mixture comprises activated carbon, chitosan, a weak cation exchanger, and a binder for binding all said reactants.

20. A method removing fouling agents from raw water as in claim 19, wherein beneficial factors are further supplied to said water, said method comprising:
collecting raw water in a chamber;
filtering out intrinsic factors of said raw water to produce filtered water;
interacting said upgraded water with a capsule containing at least one beneficial factor;
liberarting said at least a one beneficial factor into said filtered water, and
collecting said water having interacted with said capsule in a chamber.
